(19) United States
(12) Patent Application Publication
(10) Pub. No.: US 2025/0242706 A1
(43) Pub. Date: Jul. 31, 2025

(54) Structures for Mitigating Battery Charge Pad Degradations

(71) Applicant: Wing Aviation LLC, Mountain View, CA (US)

(72) Inventors: Winnie Elva Ding, Redwood City, CA (US); Jesse Hayden Blake, Palo Alto, CA (US); Elizabeth Chase Marshman, San Francisco, CA (US); Matthew Aaron Nubbe, Santa Clara, CA (US); André Peter Prager, Sunnyvale, CA (US); Cajer Steve Gong, Menlo Park, CA (US)

(21) Appl. No.: 18/428,075

(22) Filed: Jan. 31, 2024

(51) Int. Cl. B60L 53/16; B64F 1/35; H01M 10/44; H02J 7/00

(52) U.S. Cl. CPC B60L 53/16; B64F 1/35; H01M 10/44; H02J 7/0042; B60L 2200/10; H01M 2220/20

(57) ABSTRACT

An apparatus may include a substrate. The apparatus may also include a first charger terminal disposed on the substrate, including silver, and configured to apply a first electric potential to a first battery terminal of a battery. The apparatus may additionally include a second charger terminal disposed on the substrate, comprising silver, and configured to apply a second electric potential to a second battery terminal of the battery.

### BACKGROUND

Vehicle systems may operate in various environments. Some environments may include substances and/or conditions that cause and/or accelerate the degradation of components of the vehicle systems. Accordingly, it is desirable to design and implement the vehicle systems in a manner that reduced and/or prevents the degradation of components thereof.

### SUMMARY

A charge pad may be configured to charge a battery of a vehicle. Portions of the charge pad may be exposed to an ambient environment to allow an electrical connection to be formed between charger terminals of the charge pad and battery terminals of the battery. The exposed portions of the charge pad may be prone to various degradations, including corrosion caused and/or facilitated by the presence of contaminants such as water on the charge pad. The degradations may be reduced and/or eliminated by forming the charger terminals using silver, separating the charger terminals using barriers, placing the charge pad at an incline, providing drainage holes in the charge pad, and/or providing wicking material on the charge pad.

In a first example embodiment, an apparatus may include a substrate. The apparatus may also include a first charger terminal disposed on the substrate. The first charger terminal may include silver and may be configured to apply a first electric potential to a first battery terminal of a battery. The apparatus may additionally include a second charger terminal disposed on the substrate. The second charger terminal may include silver and may be configured to apply a second electric potential to a second battery terminal of the battery.

In a second example embodiment, a system for charging a battery may include a substrate. The system may also include a first charger terminal disposed on the substrate. The first charger terminal may include silver and may be configured to apply a first electric potential to a first battery terminal of the battery. The system may additionally include a second charger terminal disposed on the substrate. The second charger terminal may include silver and may be configured to apply a second electric potential to a second battery terminal of the battery.

In a third example embodiment, a method may include providing a substrate. The method may also include forming on the substrate a first charger terminal that includes silver and is configured to apply a first electric potential to a first battery terminal of a battery. The method may additionally include forming on the substrate a second charger terminal that includes silver and is configured to apply a second electric potential to a second battery terminal of the battery.

In a fourth example embodiment, a method may include positioning a vehicle on a substrate. The method may also include forming a first electrical connection between a first charger terminal and a first battery terminal of a battery of the vehicle. The first charger terminal may be disposed on the substrate, may include silver, and may be configured to apply a first electric potential to the first battery terminal. The method may additionally include forming a second electrical connection between a second charger terminal and a second battery terminal of the battery. The second charger terminal may be disposed on the substrate, may include silver, and may be configured to apply a second electric potential to the second battery terminal.

In a fifth example embodiment, a non-transitory computer-readable medium may have stored thereon instructions that, when executed by a computing device, cause the computing device to perform operations in accordance with the fourth example embodiment.

In a sixth example embodiment, a system may include a processor and a non-transitory computer-readable medium may have stored thereon instructions that, when executed by the processor, cause the processor to perform operations in accordance with the fourth example embodiment.

In a seventh example embodiment, a system may include various means for carrying out each of the operations of the third example embodiment and/or the fourth example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A illustrates an uncrewed aerial vehicle, in accordance with examples described herein.

FIG. 1B illustrates an uncrewed aerial vehicle, in accordance with examples described herein.

FIG. 1C illustrates an uncrewed aerial vehicle, in accordance with examples described herein.

FIG. 1D illustrates an uncrewed aerial vehicle, in accordance with examples described herein.

FIG. 1E illustrates an uncrewed aerial vehicle, in accordance with examples described herein.

FIG. 2 illustrates components of an uncrewed aerial system, in accordance with examples described herein.

FIG. 3 is a block diagram illustrating a distributed UAV system, in accordance with examples described herein.

FIG. 4A illustrates a charge pad, in accordance with examples described herein.

FIG. 4B illustrates a landing pad, in accordance with examples described herein.

FIGS. 5A, 5B, 5C, 5D, 5E, and 5F illustrate charge pad terminal barriers, in accordance with examples described herein.

FIG. 6 illustrates an adjustable leg of a charge pad, in accordance with examples described herein.

FIG. 7 illustrates additional liquid removal structures of a charge pad, in accordance with examples described herein.

FIG. 8 is a flow chart, in accordance with examples described herein.

FIG. 9 is a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

A charge pad may include a substrate and a plurality of charger terminals disposed on the substrate. The charger terminals may be configured to electrically connect to battery terminals of a battery of a vehicle to charge the battery. Specifically, a power source of the charge pad may be configured to apply a corresponding electric potential to two or more of the charger terminals to charge the battery. The charter terminals and the battery terminals may be configured to form a wired connection by way of one or more conductive components (e.g., wires, traces, connectors, etc.) that facilitate charging of the battery when the vehicle is disposed on the charge pad.

Accordingly, portions of the charge pad, including the charger terminals, may be exposed to an ambient environment in which the vehicle operates. Some substances present in the ambient environment may cause and/or accelerate a degradation of components of the charge pad. For example, conductive liquids such as water may, when disposed on the charge pad, cause formation of unwanted electrical connections between the charger terminals. These unwanted electrical connections may cause short circuits and/or corrosion of the conductive materials that form the charger terminals, among other potential damage to the charge pad. Accordingly, it is desirable to design the charge pad and/or the components thereof in a manner that facilitates the removal of liquids from the surface thereof and/or increases the robustness of the charge pad in the presence of liquids, to thereby extend the useful life of the charge pad.

Thus, in some implementations, the charger terminals of the charge pad may be formed using silver. For example, the charger terminals may be plated with a layer of silver, or the entirety of each charger terminal may be formed using silver. Silver may corrode slower than some metals, and the products of silver corrosion are sufficiently conductive to allow the charge pad to continue to be used to charge batteries. Thus, charge pads with charger terminals formed using silver may remain operational even after the charger terminals have corroded due to exposure to water and/or other contaminants in the environment.

Additionally or alternatively, the charger terminals may be separated using barriers that may be structured to impede the formation of unwanted electrical connections. Specifically, two adjacent charger terminals may be separated using a corresponding barrier that is disposed on and/or formed in the substrate. As one example, the barrier may include a hydrophobic material (e.g., polytetrafluoroethylene) that repels water from the barrier and onto the adjacent charger terminals. As another example, the barrier may include a ridge (e.g., triangular ridge, semicircular ridge, etc.) the extends higher than a top surface of the adjacent charger terminals, and thus splits some, most, or all liquid droplets, thereby preventing these droplets from spanning the ridge to connect the adjacent terminals. As a further example, the barrier may include a channel in the substrate that extends lower than a bottom surface of the adjacent charger terminals, and thus increases a path length between the adjacent charger terminals that the liquid would have to span to electrically connect these terminals. The channel may be covered by a channel screen that allows water to enter the channel but prevents components of the vehicle from entering the channel.

In some implementations, the charge pad may be placed at an incline to use gravity to facilitate removal of liquids from the surface of the charge pad. For example, the charge pad may include an adjustable leg that allows at least one end (e.g., a top end) of the charge pad to be elevated relative to an opposite end (e.g., a bottom end) of the charge pad, thus promoting liquid runoff from the charge pad. The incline of the charge pad may be oriented along a length of the charger terminals, thus allowing the liquid to run off along the charger terminals without obstruction by the barriers therebetween. In some cases, the charge pad may be placed on an inclined support surface, and the incline may thus be achieved without using the adjustable leg or by using the adjustable leg in combination with the incline of the support surface.

In some implementations, the charge pad may include one or more drainage holes through which water can drain off from the charge pad. These drainage holes may be placed near the bottom end of the charge pad such that any incline of the charge pad directs water towards the drainage holes. The charge pad may also include wicking material connected to and/or near the bottom end of the charge pad to wick moisture off the charge pad.

In some implementations, the charger terminals may have alternating lengths to prevent any residual liquid present near the bottom end from forming unwanted electrical connections. Specifically, every other charger terminal might extend from the top end partly, but not all the way, to the bottom end of the charge pad, thus exposing a nonconductive portion of the substrate. Any residual liquid present near the bottom end that spans across the barriers of adjacent charger terminals may thus connect a conductive charger terminal to the nonconductive portion of the substrate (rather than to another conductive charger terminal), thus avoiding an unwanted electrical connection. Any of the techniques described herein may be used independently of or in combination with one another.

### II. Example Uncrewed Vehicles

Herein, the terms “uncrewed aerial system” and “UAV” refer to any autonomous or semi-autonomous vehicle that is capable of performing some functions without a physically present human pilot. A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial vehicle” may also be used to refer to a UAV.

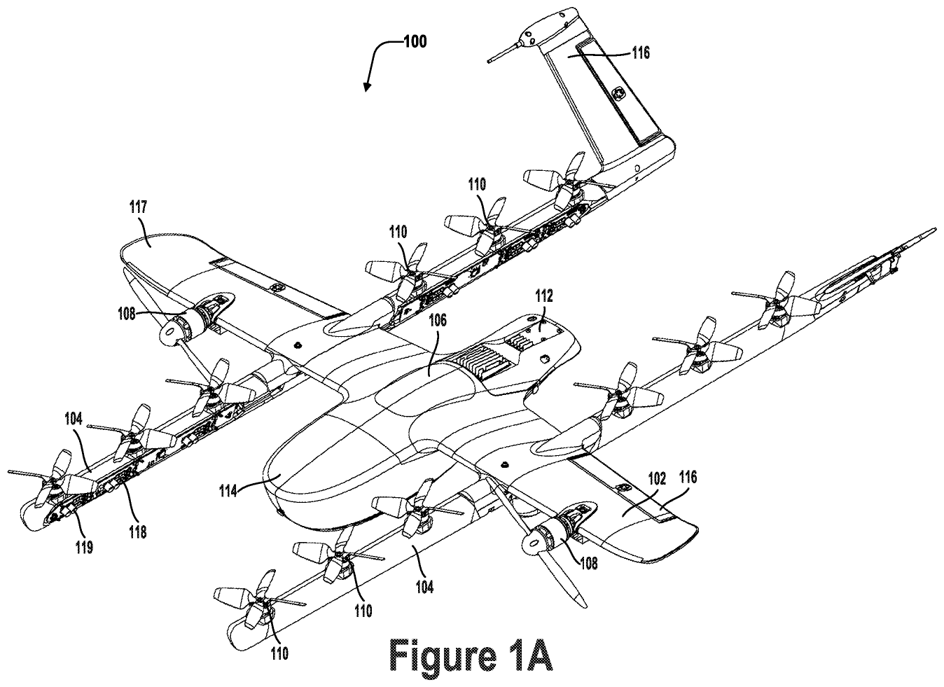

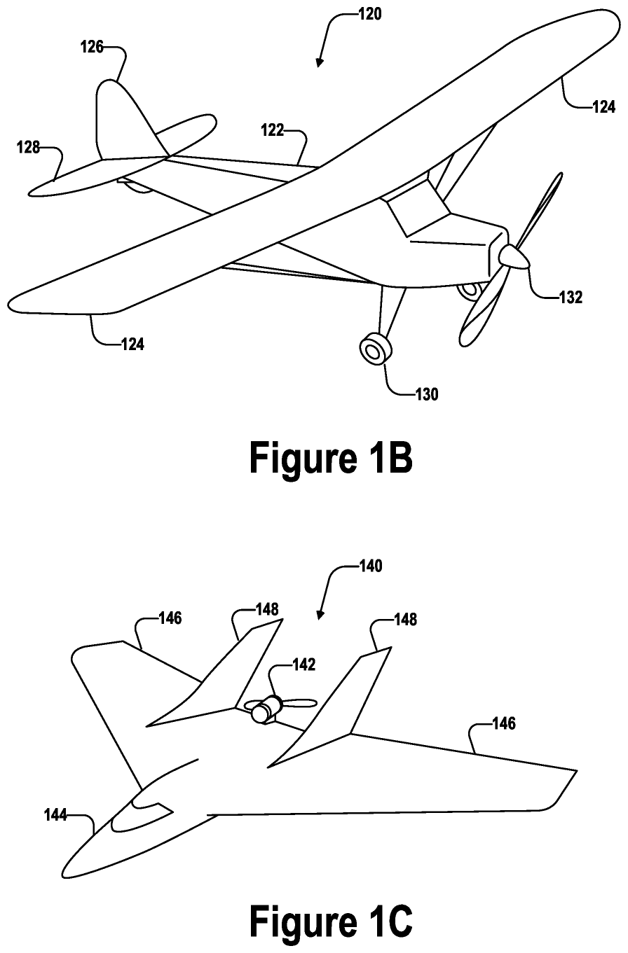

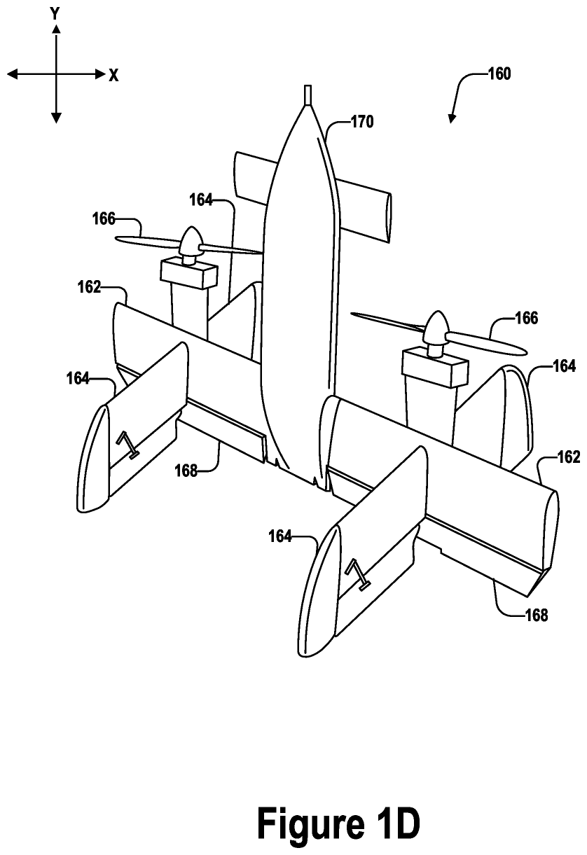

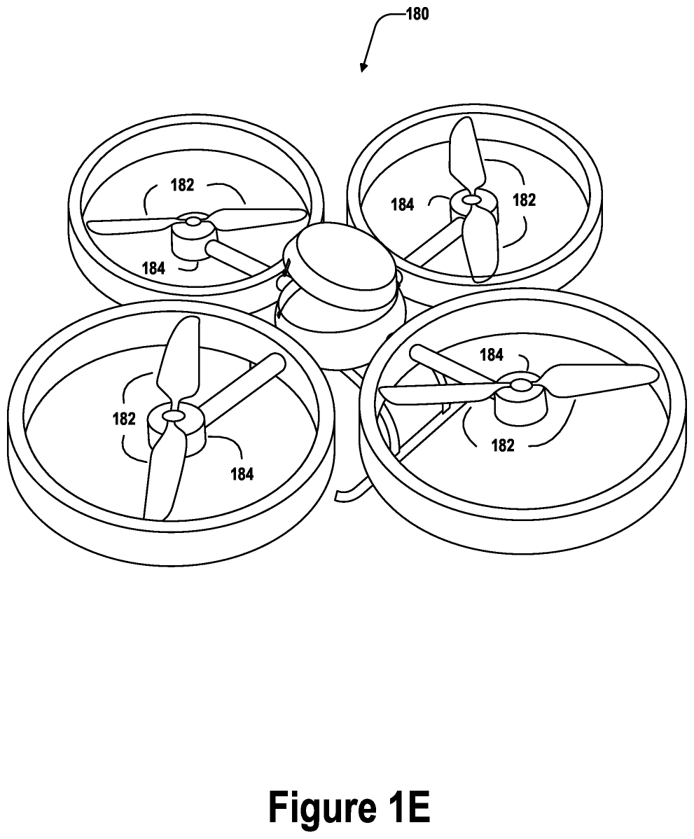

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. Fixed-wing UAV 120 includes fuselage 122, two wings 124 with an airfoil-shaped cross section to provide lift for UAV 120, vertical stabilizer 126 (or fin) to stabilize the plane's yaw (turn left or right), horizontal stabilizer 128 (also referred to as an elevator or tailplane) to stabilize pitch (tilt up or down), landing gear 130, and propulsion unit 132, which can include a motor, shaft, and propeller.

FIG. 1C shows an example of UAV 140 with a propeller in a pusher configuration. The term “pusher” refers to the fact that propulsion unit 142 is mounted at the back of UAV 140 and “pushes” the vehicle forward, in contrast to the propulsion unit 142 being mounted at the front of UAV 140. Similar to the description provided for FIGS. 1A and 1B, FIG. 1C depicts common structures used in a pusher plane, including fuselage 144, two wings 146, vertical stabilizers 148, and propulsion unit 142, which can include a motor, shaft, and propeller.

FIG. 1D shows an example tail-sitter UAV 160. In the illustrated example, tail-sitter UAV 160 has fixed wings 162 to provide lift and allow UAV 160 to glide horizontally (e.g., along the x-axis, in a position that is approximately perpendicular to the position shown in FIG. 1D). However, fixed wings 162 also allow tail-sitter UAV 160 to take off and land vertically on its own.

For example, at a launch site, tail-sitter UAV 160 may be positioned vertically (as shown) with fins 164 and/or wings 162 resting on the ground and stabilizing UAV 160 in the vertical position. Tail-sitter UAV 160 may then take off by operating propellers 166 to generate an upward thrust (e.g., a thrust that is generally along the y-axis). Once at a suitable altitude, tail-sitter UAV 160 may use flaps 168 to reorient itself in a horizontal position, such that fuselage 170 is closer to being aligned with the x-axis than the y-axis. Positioned horizontally, propellers 166 may provide forward thrust so that tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of rotorcraft 180 that is commonly referred to as a multicopter. Multicopter 180 may also be referred to as a quadcopter, as it includes four rotors 182. It should be understood that example embodiments may involve a rotorcraft with more or fewer rotors than multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 180 in greater detail, four rotors 182 provide propulsion and maneuverability for multicopter 180. More specifically, each rotor 182 includes blades that are attached to motor 184. Configured as such, rotors 182 may allow multicopter 180 to take off and land vertically, to maneuver in any direction, and/or to hover. Further, the pitch of the blades may be adjusted as a group and/or differentially, and may allow multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Example UAV Components

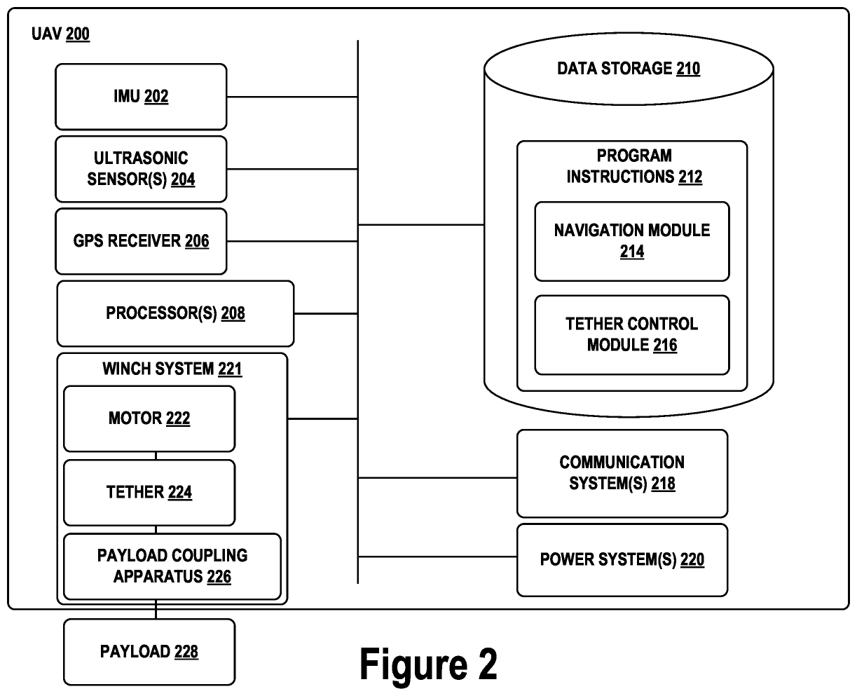

FIG. 2 is a simplified block diagram illustrating components of UAV 200, according to an example embodiment. UAV 200 may take the form of, or be similar in form to, one of UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include inertial measurement unit (IMU) 202, ultrasonic sensor(s) 204, and GPS receiver 206, among other possible sensors and sensing systems.

In the illustrated embodiment, UAV 200 also includes processor(s) 208. Processor 208 may be a general-purpose processor or a special purpose processor (e.g., digital signal processors, application specific integrated circuits, etc.). Processor(s) 208 can be configured to execute computer-readable program instructions 212 that are stored in data storage 210 and are executable to provide the functionality of a UAV described herein.

Data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of processor(s) 208. In some embodiments, data storage 210 can be implemented using a single physical device (e.g., one optical, magnetic, organic or other memory or disc storage unit), while in other embodiments, data storage 210 can be implemented using two or more physical devices.

As noted, data storage 210 can include computer-readable program instructions 212 and perhaps additional data, such as diagnostic data of UAV 200. As such, data storage 210 may include program instructions 212 to perform or facilitate some or all of the UAV functionality described herein. For instance, in the illustrated embodiment, program instructions 212 include navigation module 214 and tether control module 216.

In an illustrative embodiment, IMU 202 may include both an accelerometer and a gyroscope, which may be used together to determine an orientation of UAV 200. In particular, the accelerometer can measure the orientation of the vehicle with respect to earth, while the gyroscope measures the rate of rotation around an axis. IMUs are commercially available in low-cost, low-power packages. For instance, IMU 202 may take the form of or include a miniaturized MicroElectroMechanical System (MEMS) or a NanoElectroMechanical System (NEMS). Other types of IMUs may also be utilized.

IMU 202 may include other sensors, in addition to accelerometers and gyroscopes, which may help to better determine position and/or help to increase autonomy of UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200. Such GPS data may be utilized by UAV 200 for various functions. As such, the UAV may use GPS receiver 206 to help navigate to the caller's location, as indicated, at least in part, by the GPS coordinates provided by their mobile device. Other examples are also possible.

Navigation module 214 may provide functionality that allows UAV 200 to, for example, move about its environment and reach a desired location. To do so, navigation module 214 may control the altitude and/or direction of flight by controlling the mechanical features of the UAV that affect flight (e.g., its rudder(s), elevator(s), aileron(s), and/or the speed of its propeller(s)).

In order to navigate UAV 200 to a target location, navigation module 214 may implement various navigation techniques, such as map-based navigation and localization-based navigation, for instance. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of its environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, navigation module 214 and/or other components and systems of UAV 200 may be configured for “localization” to more precisely navigate to the scene of a target location. More specifically, it may be desirable in certain situations for a UAV to be within a threshold distance of the target location where payload 228 is being delivered by a UAV (e.g., within a few feet of the target destination). To this end, a UAV may use a two-tiered approach in which it uses a more—general location-determination technique to navigate to a general area that is associated with the target location, and then use a more-refined location-determination technique to identify and/or navigate to the target location within the general area.

For example, UAV 200 may navigate to the general area of a target destination where payload 228 is being delivered using waypoints and/or map-based navigation. The UAV may then switch to a mode in which it utilizes a localization process to locate and travel to a more specific location. For instance, if UAV 200 is to deliver a payload to a user's home, UAV 200 may need to be substantially close to the target location in order to avoid delivery of the payload to undesired areas (e.g., onto a roof, into a pool, onto a neighbor's property, etc.). However, a GPS signal may only get UAV 200 so far (e.g., within a block of the user's home). A more precise location-determination technique may then be used to find the specific target location.

Various types of location-determination techniques may be used to accomplish localization of the target delivery location once UAV 200 has navigated to the general area of the target delivery location. For instance, UAV 200 may be equipped with one or more sensory systems, such as, for example, ultrasonic sensors 204, infrared sensors (not shown), and/or other sensors, which may provide input that navigation module 214 utilizes to navigate autonomously or semi-autonomously to the specific target location.

As another example, once UAV 200 reaches the general area of the target delivery location (or of a moving subject such as a person or their mobile device), UAV 200 may switch to a “fly-by-wire” mode where it is controlled, at least in part, by a remote operator, who can navigate UAV 200 to the specific target location. To this end, sensory data from UAV 200 may be sent to the remote operator to assist them in navigating UAV 200 to the specific location.

As yet another example, UAV 200 may include a module that is able to signal to a passer—by for assistance in reaching the specific target delivery location. For example, the UAV 200 may display a visual message requesting such assistance in a graphic display or play an audio message or tone through speakers to indicate the need for such assistance, among other possibilities. Such a visual or audio message might indicate that assistance is needed in delivering UAV 200 to a particular person or a particular location, and might provide information to assist the passer—by in delivering UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once UAV 200 arrives at the general area of a target delivery location, UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, UAV 200 may be configured to navigate by “sourcing” such directional signals—in other words, by determining where the signal is strongest and navigating accordingly. As another example, a mobile device can emit a frequency, either in the human range or outside the human range, and UAV 200 can listen for that frequency and navigate accordingly. As a related example, if UAV 200 is listening for spoken commands, then UAV 200 could utilize spoken statements, such as “I'm over here!” to source the specific location of the person requesting delivery of a payload.

In an alternative arrangement, a navigation module may be implemented at a remote computing device, which communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

In a further aspect, UAV 200 includes one or more communication system(s) 218. Communications system(s) 218 may include one or more wireless interfaces and/or one or more wireline interfaces, which allow UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, UAV 200 may include communication systems 218 that allow for both short-range communication and long-range communication. For example, UAV 200 may be configured for short-range communications using Bluetooth and for long-range communications under a CDMA protocol. In such an embodiment, UAV 200 may be configured to function as a “hot spot;” or in other words, as a gateway or proxy between a remote support device and one or more data networks, such as a cellular network and/or the Internet. Configured as such, UAV 200 may facilitate data communications that the remote support device would otherwise be unable to perform by itself.

For example, UAV 200 may provide a WiFi connection to a remote device, and serve as a proxy or gateway to a cellular service provider's data network, which the UAV might connect to under an LTE or a 3G protocol, for instance. UAV 200 could also serve as a proxy or gateway to a high-altitude balloon network, a satellite network, or a combination of these networks, among others, which a remote device might not be able to otherwise access.

In a further aspect, UAV 200 may include power system(s) 220. Power system(s) 220 may include one or more batteries for providing power to UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

UAV 200 may employ various systems and configurations in order to transport and deliver payload 228. In some implementations, payload 228 of UAV 200 may include or take the form of a “package” designed to transport various goods to a target delivery location. For example, UAV 200 can include a compartment, in which an item or items may be transported. Such a package may one or more food items, purchased goods, medical items, or any other object(s) having a size and weight suitable to be transported between two locations by the UAV. In other embodiments, payload 228 may simply be the one or more items that are being delivered (e.g., without any package housing the items).

In some embodiments, payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

In order to deliver the payload, the UAV may include winch system 221 controlled by tether control module 216 in order to lower payload 228 to the ground while UAV 200 hovers above. As shown in FIG. 2, winch system 221 may include tether 224, and tether 224 may be coupled to payload 228 by payload coupling apparatus 226. Tether 224 may be wound on a spool that is coupled to motor 222 of the UAV. Motor 222 may take the form of a DC motor (e.g., a servo motor) that can be actively controlled by a speed controller. Tether control module 216 can control the speed controller to cause motor 222 to rotate the spool, thereby unwinding or retracting tether 224 and lowering or raising payload coupling apparatus 226. In practice, the speed controller may output a desired operating rate (e.g., a desired RPM) for the spool, which may correspond to the speed at which tether 224 and payload 228 should be lowered towards the ground. Motor 222 may then rotate the spool so that it maintains the desired operating rate.

In order to control motor 222 via the speed controller, tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as motor 222 causes rotation of the spool, a rotary encoder may be used to measure this rotation. In doing so, the rotary encoder may be used to convert a rotary position to an analog or digital electronic signal used by tether control module 216 to determine the amount of rotation of the spool from a fixed reference angle and/or to an analog or digital electronic signal that is representative of a new rotary position, among other options. Other examples are also possible.

Based on the data from the speed sensor, tether control module 216 may determine a rotational speed of motor 222 and/or the spool and responsively control motor 222 (e.g., by increasing or decreasing an electrical current supplied to motor 222) to cause the rotational speed of motor 222 to match a desired speed. When adjusting the motor current, the magnitude of the current adjustment may be based on a proportional-integral-derivative (PID) calculation using the determined and desired speeds of motor 222. For instance, the magnitude of the current adjustment may be based on a present difference, a past difference (based on accumulated error over time), and a future difference (based on current rates of change) between the determined and desired speeds of the spool.

In some embodiments, tether control module 216 may vary the rate at which tether 224 and payload 228 are lowered to the ground. For example, the speed controller may change the desired operating rate according to a variable deployment-rate profile and/or in response to other factors in order to change the rate at which payload 228 descends toward the ground. To do so, tether control module 216 may adjust an amount of braking or an amount of friction that is applied to tether 224. For example, to vary the tether deployment rate, UAV 200 may include friction pads that can apply a variable amount of pressure to tether 224. As another example, UAV 200 can include a motorized braking system that varies the rate at which the spool lets out tether 224. Such a braking system may take the form of an electromechanical system in which motor 222 operates to slow the rate at which the spool lets out tether 224. Further, motor 222 may vary the amount by which it adjusts the speed (e.g., the RPM) of the spool, and thus may vary the deployment rate of tether 224. Other examples are also possible.

In some embodiments, tether control module 216 may be configured to limit the motor current supplied to motor 222 to a maximum value. With such a limit placed on the motor current, there may be situations where motor 222 cannot operate at the desired rate specified by the speed controller. For instance, there may be situations where the speed controller specifies a desired operating rate at which motor 222 should retract tether 224 toward UAV 200, but the motor current may be limited such that a large enough downward force on tether 224 would counteract the retracting force of motor 222 and cause tether 224 to unwind instead. A limit on the motor current may be imposed and/or altered depending on an operational state of UAV 200.

In some embodiments, tether control module 216 may be configured to determine a status of tether 224 and/or payload 228 based on the amount of current supplied to motor 222. For instance, if a downward force is applied to tether 224 (e.g., if payload 228 is attached to tether 224 or if tether 224 gets snagged on an object when retracting toward UAV 200), tether control module 216 may need to increase the motor current in order to cause the determined rotational speed of motor 222 and/or spool to match the desired speed. Similarly, when the downward force is removed from tether 224 (e.g., upon delivery of payload 228 or removal of a tether snag), tether control module 216 may need to decrease the motor current in order to cause the determined rotational speed of motor 222 and/or spool to match the desired speed. As such, tether control module 216 may be configured to monitor the current supplied to motor 222. For instance, tether control module 216 could determine the motor current based on sensor data received from a current sensor of the motor or a current sensor of power system 220. In any case, based on the current supplied to motor 222, tether control module 216 may determine if payload 228 is attached to tether 224, if someone or something is pulling on tether 224, and/or if payload coupling apparatus 226 is pressing against UAV 200 after retracting tether 224. Other examples are possible as well.

During delivery of payload 228, payload coupling apparatus 226 can be configured to secure payload 228 while being lowered from the UAV by tether 224, and can be further configured to release payload 228 upon reaching ground level. Payload coupling apparatus 226 can then be retracted to the UAV by reeling in tether 224 using motor 222.

In some implementations, payload 228 may be passively released once it is lowered to the ground. For example, a passive release mechanism may include one or more swing arms adapted to retract into and extend from a housing. An extended swing arm may form a hook on which payload 228 may be attached. Upon lowering the release mechanism and payload 228 to the ground via a tether, a gravitational force as well as a downward inertial force on the release mechanism may cause payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of payload 228 no longer forces the swing arm to extend from the housing. Retracting the swing arm into the housing may reduce the likelihood of the release mechanism snagging payload 228 or other nearby objects when raising the release mechanism toward the UAV upon delivery of payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, UAV 200 could include an air-bag drop system or a parachute drop system. Alternatively, UAV 200 carrying a payload could simply land on the ground at a delivery location. Other examples are also possible.

### IV. Example UAV Deployment Systems

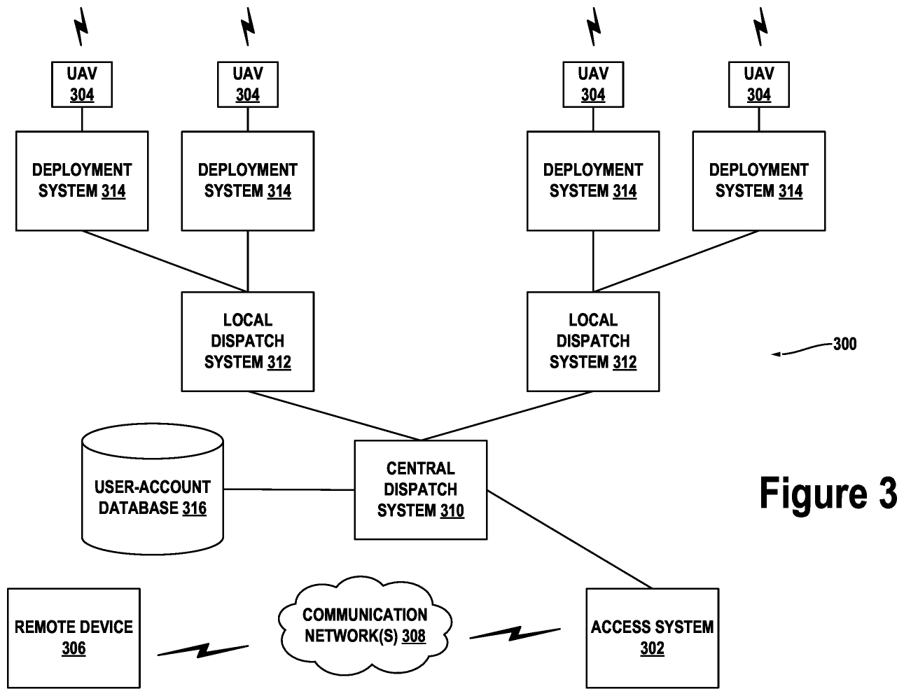

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, access system 302 may allow for interaction with, control of, and/or utilization of a network of UA Vs 304. In some embodiments, access system 302 may be a computing system that allows for human-controlled dispatch of UAVs 304. As such, the control system may include or otherwise provide a user interface through which a user can access and/or control UAVs 304.

In some embodiments, dispatch of UAVs 304 may additionally or alternatively be accomplished via one or more automated processes. For instance, access system 302 may dispatch one of UAVs 304 to transport a payload to a target location, and the UAV may autonomously navigate to the target location by utilizing various on-board sensors, such as a GPS receiver and/or other various navigational sensors.

Further, access system 302 may provide for remote operation of a UAV. For instance, access system 302 may allow an operator to control the flight of a UAV via its user interface. As a specific example, an operator may use access system 302 to dispatch one of UAVs 304 to a target location. The dispatched UAV may then autonomously navigate to the general area of the target location. At this point, the operator may use access system 302 to take control of the dispatched UAV and navigate the dispatched UAV to the target location (e.g., to a particular person to whom a payload is being transported). Other examples of remote operation of a UAV are also possible.

In an illustrative embodiment, UAVs 304 may take various forms. For example, each of UAVs 304 may be a UAV such as those illustrated in FIG. 1A, 1B, 1C, 1D, 1E, or 2. However, UAV system 300 may also utilize other types of UAVs without departing from the scope of the invention. In some implementations, all of UAVs 304 may be of the same or a similar configuration. However, in other implementations, UAVs 304 may include a number of different types of UAVs. For instance, UAVs 304 may include a number of types of UAVs, with each type of UAV being configured for a different type or types of payload delivery capabilities.

UAV system 300 may further include remote device 306, which may take various forms. Generally, remote device 306 may be any device through which a direct or indirect request to dispatch a UAV can be made. Note that an indirect request may involve any communication that may be responded to by dispatching a UAV, such as requesting a package delivery. In an example embodiment, remote device 306 may be a mobile phone, tablet computer, laptop computer, personal computer, or any network-connected computing device. Further, in some instances, remote device 306 may not be a computing device. As an example, a standard telephone, which allows for communication via plain old telephone service (POTS), may serve as remote device 306. Other types of remote devices are also possible.

Further, remote device 306 may be configured to communicate with access system 302 via one or more types of communication network(s) 308. For example, remote device 306 may communicate with access system 302 (or a human operator of access system 302) by communicating over a POTS network, a cellular network, and/or a data network such as the Internet. Other types of networks may also be utilized.

In some embodiments, remote device 306 may be configured to allow a user to request pick-up of one or more items from a certain source location and/or delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, UAV system 300 may receive location information (e.g., GPS coordinates, etc.) from the user's mobile phone, or any other device on the user's person, such that a UAV can navigate to the user's location (as indicated by their mobile phone).

In an illustrative arrangement, central dispatch system 310 may be a server or group of servers, which is configured to receive dispatch messages requests and/or dispatch instructions from access system 302. Such dispatch messages may request or instruct central dispatch system 310 to coordinate the deployment of UAVs to various target locations. Central dispatch system 310 may be further configured to route such requests or instructions to one or more local dispatch systems 312. To provide such functionality, central dispatch system 310 may communicate with access system 302 via a data network, such as the Internet or a private network that is established for communications between access systems and automated dispatch systems.

In the illustrated configuration, central dispatch system 310 may be configured to coordinate the dispatch of UAVs 304 from a number of different local dispatch systems 312. As such, central dispatch system 310 may keep track of which ones of UAVs 304 are located at which ones of local dispatch systems 312, which UAVs 304 are currently available for deployment, and/or which services or operations each of UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when central dispatch system 310 receives a request for UAV-related service (e.g., transport of an item) from access system 302, central dispatch system 310 may select a specific one of UAVs 304 to dispatch. Central dispatch system 310 may accordingly instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the support is requested and leave the selection of a particular one of UAVs 304 to local dispatch system 312.

In an example configuration, local dispatch system 312 may be implemented as a computing system at the same location as deployment system(s) 314 that it controls. For example, a particular one of local dispatch system 312 may be implemented by a computing system installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and UAV(s) 304.

Numerous variations on and alternatives to the illustrated configuration of UAV system 300 are possible. For example, in some embodiments, a user of remote device 306 could request delivery of a package directly from central dispatch system 310. To do so, an application may be implemented on remote device 306 that allows the user to provide information regarding a requested delivery, and generate and send a data message to request that UAV system 300 provide the delivery. In such an embodiment, central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to central dispatch system 310, local dispatch system(s) 312, access system 302, and/or deployment system(s) 314 may be combined in a single system, implemented in a more complex system (e.g., having more layers of control), and/or redistributed among central dispatch system 310, local dispatch system(s) 312, access system 302, and/or deployment system(s) 314 in various ways.

Yet further, while each local dispatch system 312 is shown as having two associated deployment systems 314, a given local dispatch system 312 may alternatively have more or fewer associated deployment systems 314. Similarly, while central dispatch system 310 is shown as being in communication with two local dispatch systems 312, central dispatch system 310 may alternatively be in communication with more or fewer local dispatch systems 312.

In a further aspect, deployment systems 314 may take various forms. In some implementations, some or all of deployment systems 314 may be a structure or system that passively facilitates a UAV taking off from a resting position to begin a flight. For example, some or all of deployment systems 314 may take the form of a landing pad, a hangar, and/or a runway, among other possibilities. As such, a given deployment system 314 may be arranged to facilitate deployment of one UAV 304 at a time, or deployment of multiple UAVs (e.g., a landing pad large enough to be utilized by multiple UAVs concurrently).

Additionally or alternatively, some or all of deployment systems 314 may take the form of or include systems for actively launching one or more of UAVs 304. Such launch systems may include features that provide for an automated UAV launch and/or features that allow for a human-assisted UAV launch. Further, a given deployment system 314 may be configured to launch one particular UAV 304, or to launch multiple UAVs 304.

Note that deployment systems 314 may also be configured to passively facilitate and/or actively assist a UAV when landing. For example, the same landing pad could be used for take-off and landing. Deployment system 314 could also include other structures and/or systems to assist and/or facilitate UAV landing processes.

Deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, local dispatch systems 312 (along with their respective deployment system(s) 314 may be strategically distributed throughout an area such as a city. For example, local dispatch systems 312 may be strategically distributed such that each local dispatch systems 312 is proximate to one or more payload pickup locations (e.g., near a restaurant, store, or warehouse). However, local dispatch systems 312 may be distributed in other ways, depending upon the particular implementation.

As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, UAV system 300 may include or have access to user-account database 316. User-account database 316 may include data for a number of user accounts, and which are each associated with one or more person. For a given user account, user-account database 316 may include data related to or useful in providing UAV-related services. Typically, the user data associated with each user account is optionally provided by an associated user and/or is collected with the associated user's permission.

Further, in some embodiments, a person may be required to register for a user account with UAV system 300, if they wish to be provided with UAV-related services by UAVs 304 from UAV system 300. As such, user-account database 316 may include authorization information for a given user account (e.g., a user name and password), and/or other information that may be used to authorize access to a user account.

In some embodiments, a person may associate one or more of their devices with their user account, such that they can access the services of UAV system 300. For example, when a person uses an associated mobile phone to, e.g., place a call to an operator of access system 302 or send a message requesting a UAV-related service to a dispatch system, the phone may be identified via a unique device identification number, and the call or message may then be attributed to the associated user account. Other examples are also possible.

### V. Example Battery Charge Pad

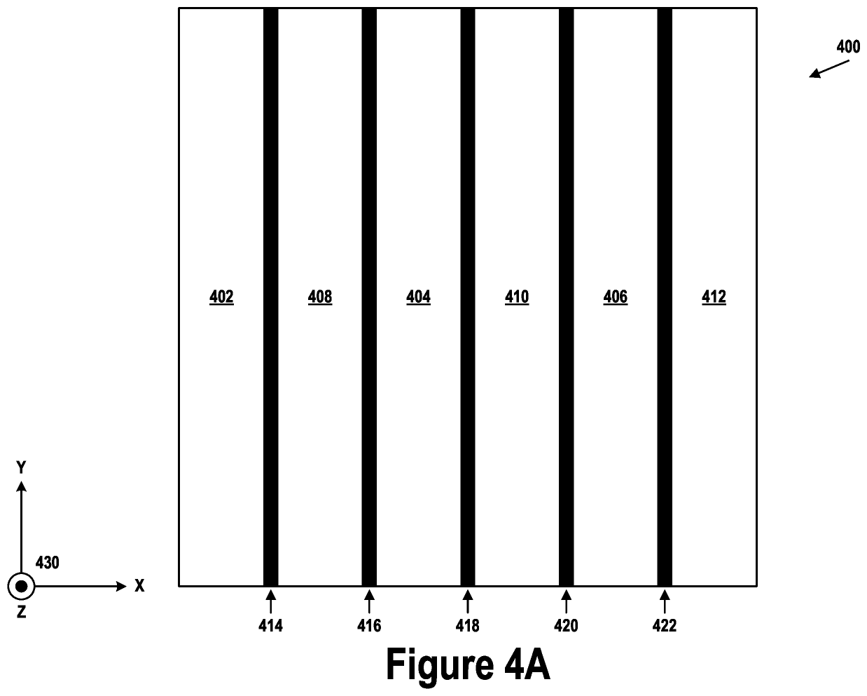

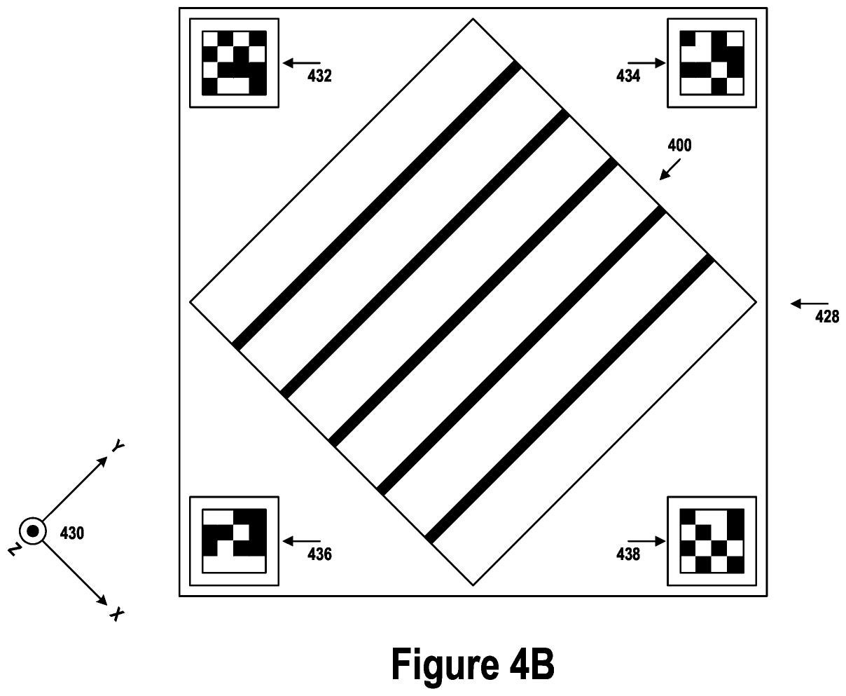

FIG. 4A illustrates a top-down view of an example charge pad 400. Charge pad 400 may be used by a vehicle to charge a battery of the vehicle. The vehicle may be an aerial vehicle as described in FIGS. 1A-3, and/or a ground vehicle (e.g., robotic device, autonomous ground vehicle, etc.), among other possibilities. Charge pad 400 may alternatively be referred to as a battery charge pad, a charger, and/or a battery charger, among other possibilities. The vehicle may be configured to place itself on charge pad 400 by, for example, landing on, driving onto, parking on, and/or otherwise moving onto charge pad 400. The battery of the vehicle may be charged by way of one or more electrical connections physically formed between the battery and charge pad 400. Reference frame 430 is shown in each of FIGS. 4A-7 to illustrate the relative orientations of the views shown in these figures.

Charge pad 400 may include a substrate and a plurality of charger terminals disposed on the substrate. The plurality of charger terminals may be configured to make electrical contact with two or more battery terminals of the battery. Specifically, charge pad 400 may include charger terminals 402, 404, and 406 (“charger terminals 402-406”), each of which may be configured to apply a first electric potential to a first battery terminal of the battery. Charge pad 400 may also include charger terminals 408, 410, and 412 (“charger terminals 408-412”), each of which may be configured to apply a second electric potential to a second battery terminal of the battery.

Each of charger terminals 402-406 and 408-412 (“charger terminals 402-412”) may be electrically connectable to one or more battery terminals using one or more conductive electrical components (e.g., pins, traces, vias, wires, etc.) placed between one or more of charger terminals 402-412 and the battery. In some implementations, each of charger terminals 402-412 may include a layer of conductive material configured to allow one or more conductive components of the vehicle and/or the battery to form an electrical connection to charge pad 400. The substrate may be present under charger terminals 402-412 and is thus not shown in the top-down view of FIG. 4A.

Charge pad 400 may include a plurality of barriers 414-422 configured to physically and electrically separate adjacent charger terminals. Specifically, charge pad 400 may include barrier 414 separating charger terminals 402 and 408, barrier 416 separating charger terminals 408 and 404, barrier 418 separating charger terminals 404 and 410, barrier 420 separating charger terminals 410 and 406, and barrier 422 separating charger terminals 406 and 412. In some cases, barriers 414-422 may be formed by a nonconductive material disposed on the substrate between charger terminals 402-412 (i.e., the electrical isolation may be provided by the addition of an electrically isolating material). In other cases, barriers 414-422 may be formed by the absence of material on and/or the removal of material from the substrate between charger terminals 402-412 (i.e., the electrical isolation may be provided by the absence of an electrically conductive material). Barriers 414-422 may alternatively be referred to as terminal barriers, terminal separators, and/or terminal isolators, among other possibilities.

Charge pad 400 may include a power supply (not shown) configured to place each of charger terminals 402-406 at the first electric potential, and each of charger terminals 408-412 at the second electric potential. For example, the first electric potential may be zero Volts, and the second electric potential may be a positive voltage configured to charge the battery. The positive voltage may be an integer multiple of a predetermined charge voltage associated with an individual cell of the type of battery configured to be charged by charge pad 400. For example, when charge pad 400 is configured to charge lithium polymer batteries, and each lithium polymer battery cell is associated with an operating voltage range of 3.2 Volts to 4.2 Volts, the positive charge voltage for a battery with four cells may be 16.8 Volts (i.e., (4.2 Volts/cell) (4 cells)=16.8 Volts). In general, charger terminals 402-412 may be placed at any combination of electric potentials necessary to apply to the battery a potential difference configured to charge the battery. The power supply may operate to provide a constant voltage (e.g., selected to match a charge voltage of the battery), a constant current (e.g., selected to match the battery's ability to handle different currents), or constant current and constant voltage. Charge pad 400 may allow the power supply to connect to the battery, or to a power converter (e.g., DC to DC or AC to DC) of the vehicle that is in turn connected to the battery.

Charger terminals 402-412 may be arranged on the substrate such that charge pad 400 is configured to charge the battery regardless of the orientation of the vehicle on charge pad 400. Specifically, charger terminals 402-406 may be spatially alternated with charger terminals 408-412, and each of charger terminals 402-412 may have a corresponding width along the x-axis, such that any orientation of the vehicle on charge pad 400 results in the vehicle electrically connecting to at least one of charger terminals 402-406 and at least one of charger terminals 408-412. The electrical connection between charge pad 400 and the battery may be established using, for example, two or more pogo pins on the vehicle. The arrangement of these pogo pins on the vehicle may correspond to the sizing and spatial alternation of charger terminals 402-412.

FIG. 4B illustrates charge pad 400 used as part of a landing pad 428 for an aerial vehicle. Landing pad 428 may include charge pad 400 and fiducial markers 432, 434, 436, and 438 (“fiducial markers 432-438”) that may be used by the aerial vehicle to locate landing pad 428 and/or charge pad 400 and thereby facilitate landing of the aerial vehicle thereon. Charge pad 400 may be rotated by 45 degrees relative to a rectangular base of landing pad 428 to allow fiducial markers 432-438 to be placed in the corners of the rectangular base of landing pad 428. This arrangement may allow a smaller landing pad base to be used to fit both charge pad 400 and fiducial markers 432-438. In some implementations, an orientation of charge pad 400 may be aligned with an orientation of the base of landing pad 428 (i.e., the relative angle of rotation therebetween may be zero degrees), and the base of landing pad 428 may be enlarged to accommodate both charge pad 400 and fiducial markers 432-438.

Turning back to FIG. 4A, in order to allow each of charger terminals 402-412 to establish a wired electrical connection with one or more of the battery terminals of the battery, charge pad 400 may be exposed to an ambient environment (e.g., the environment in which the vehicle operates). As one example, a top layer of conductive material of charger terminals 402-412 may be directly exposed to the ambient environment (e.g., might not be coated with another material) to allow for formation of a physical conductive path (i.e., a wired electrical connection) between the power supply and the battery. As another example, the top layer of the conductive material of charger terminals 402-412 may be coated with another material, but this coating material may be sufficiently thin and/or compliant to allow for formation of the physical conductive path, and may thus nevertheless permit the contents of the ambient environment to access and react with charger terminals 402-412.

Accordingly, the materials that form charger terminals 402-412 may be exposed to various substances present in the environment, some of which may cause, induce, facilitate, and/or accelerate degradation of charger terminals 402-412, the substrate, and/or other parts of charge pad 400. For example, precipitation and/or condensation may cause water (including any solutes dissolved therein) to build up on charge pad 400, wind may cause dust and/or other debris to build up on charge pad 400, and/or gasses present in the environment may react with the materials that make up charge pad 400 and/or accumulate thereon, among other possibilities.

Conductive liquids such as water may cause inadvertent electrical connections to be established between charger terminals 402-412, resulting in short circuits and/or electrochemical reactions between different materials, among other undesirable effects. Such inadvertent electrical connections may damage charger terminals 402-412, the substrate, and/or other parts of charge pad 400. Further, water, other liquids present on charge pad 400, and/or gasses present in the environment may cause oxidation, passivation, and/or other types of degradation of charger terminals 402-412. Thus, exposure of charge pad 400 and/or components thereof to the environment may increase the rate and/or risk of degradation, breakdown, and/or loss of functionality of charge pad 400 and/or components thereof. Accordingly, described herein are techniques, structures, methods, and/or approaches that may reduce the amount and/or rate of degradation experienced by charge pad 400 due to being placed in the ambient environment.

### VI. Example Charger Terminal Materials

Charger terminals 402-412 of charge pad 400 may be formed using silver. In one example, an entirety of each of charger terminals 402-412 may be formed using silver. In another example, each of charger terminals 402-412 may include a conductive body that is plated with the silver. The conductive body may be formed using a conductive material other than silver (e.g., copper, aluminum, tin, etc.). Thus, the conductive body may be formed using metal that is less expensive than silver, while the silver may be used to protect this less expensive metal from corrosion and/or degradation. Charger terminals 402-412 may be formed using silver by etching a layer of silver formed on the substrate to define charger terminals 402-412, using immersion silver plating (e.g., when the conductive body is formed using copper) to form a layer of silver on top of the conductive bodies of charger terminals 402-412, and/or applying individual strips of silver to the substrate to define charger terminals 402-412, among other possibilities.

Using silver to form charger terminals 402-412 may provide several advantages. First, although silver may corrode, the corrosion products are conductive, whereas the corrosion products of most other metals suitable for use in electrical terminals are not sufficiently conductive. Second, using silver may allow for a higher electrical connection success rates than other metals. Third, the silver may provide a softer surface than other metals, and may thus reduce the amount of wear experienced by the electrical contact points (e.g., pogo pins) on the vehicle. Fourth, using silver may allow charge pad 400 to be used for longer periods of time between repairs and/or refurbishments compared to other metals, thus reducing the amount of human intervention involved in operating a fleet of charge pads. Fifth, the silver may provide a relatively low contact resistance at least at the beginning of life of charge pad 400.

Specifically, the corrosion products of silver may include silver oxide (Ag₂O) and silver sulfide (Ag₂S), among others. The corrosion products may be sufficiently conductive to allow charge pad 400 to continue operating to charge batteries of vehicles even after charger terminals 402-412 develop corrosion. In some cases, driving a sufficiently large current through a charger terminal (e.g., a current causing at least 0.2V drop across the charger terminal) may cause a breakdown of the corrosion products, thereby at least temporarily increasing a local conductivity at and/or around the point of contact between the charger terminal and the vehicle. The breakdown of the corrosion products may be caused by an increase in temperature at and/or around the point of contact due to the current flowing therethrough.

Thus, in some cases, the power supply may be configured to drive a corrosion breakdown current through one or more of charger terminals 402-412 based on and or in response to the battery being connected to charge pad 400. The corrosion breakdown current may be driven for a predetermined period of time, and may be selected to cause a voltage drop that is sufficiently large (e.g., 0.2V or higher) to cause breakdown of silver corrosion products present on charger terminals 402-412. After the predetermined period of time, the power supply may be configured to drive a charging current through the one or more of charger terminals 402-412, where the charging current is smaller than the corrosion breakdown current. The vehicle may remain stationary on charge pad 400 while both the corrosion breakdown current and the charging current are driven by the power supply, thus allowing the charging current to be driven through the region of increased local conductivity in the one or more of charger terminals 402-412.

In some embodiments, silver may be replaced by and/or used in combination with another corrosion-resistant metal (e.g., gold, tin, and/or nickel). For example, charger terminals 402-412 may be formed using gold. An entirety of each of charger terminals 402-412 may be formed using gold, or each of charger terminals 402-412 may include a conductive body that is plated with the gold. The conductive body may be formed using a conductive material other than gold (e.g., copper, aluminum, tin, etc.). Thus, the conductive body may be formed using metal that is less expensive than gold, while the gold may be used to protect this less expensive metal from corrosion and/or degradation. Charger terminals 402-412 may be formed using gold by etching a layer of gold formed on the substrate to define charger terminals 402-412, using electroless nickel immersion gold (ENIG) plating and/or electroless nickel electroless palladium immersion gold plating (ENIPIG) (e.g., when the conductive body is formed using nickel) to form a layer of gold on top of the conductive bodies of charger terminals 402-412, hard gold plating, and/or applying individual strips of gold to the substrate to define charger terminals 402-412, among other possibilities.

### VII. Example Barrier Structures

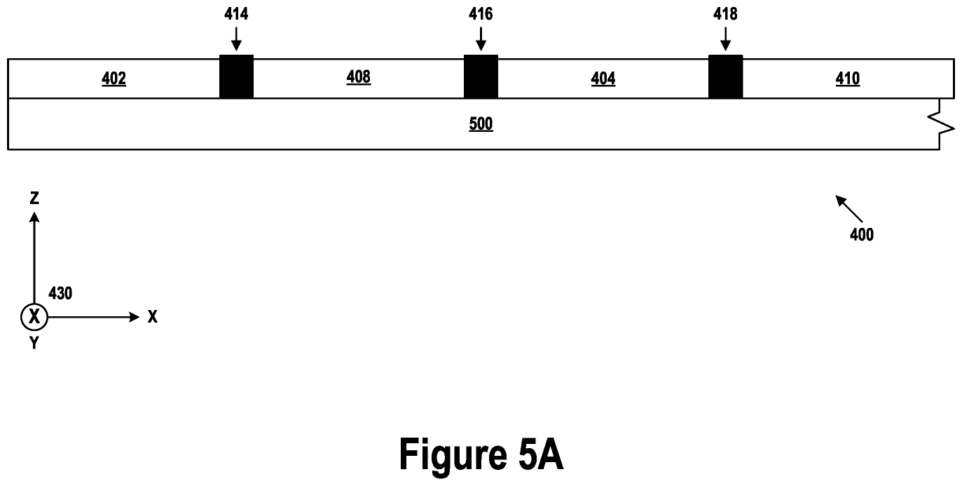

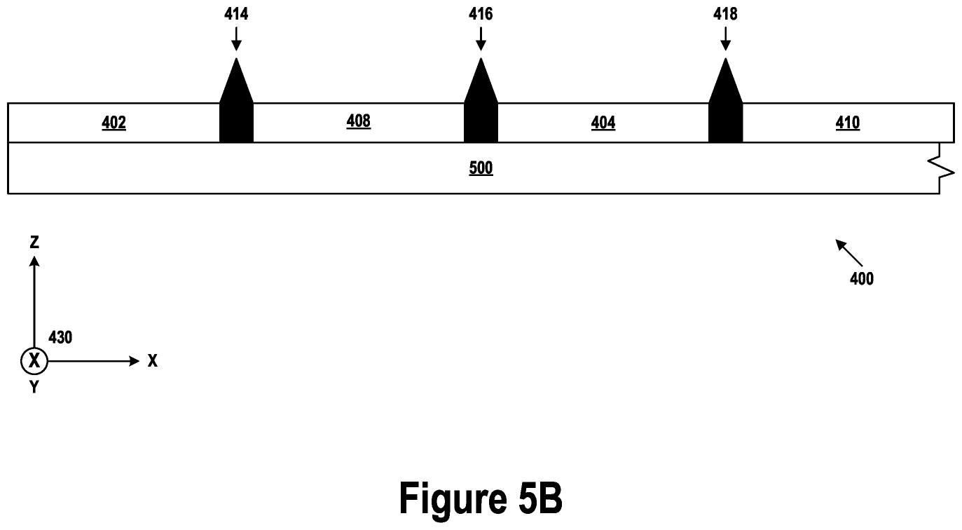

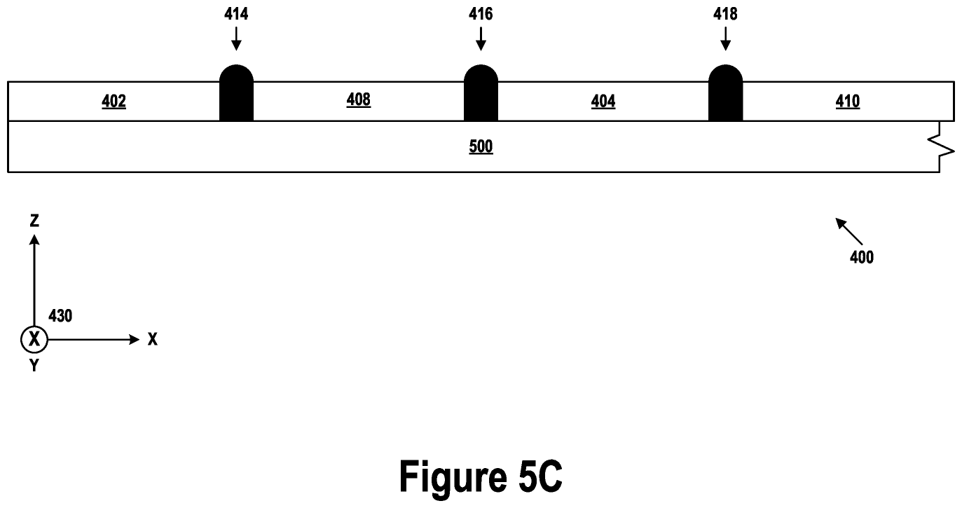

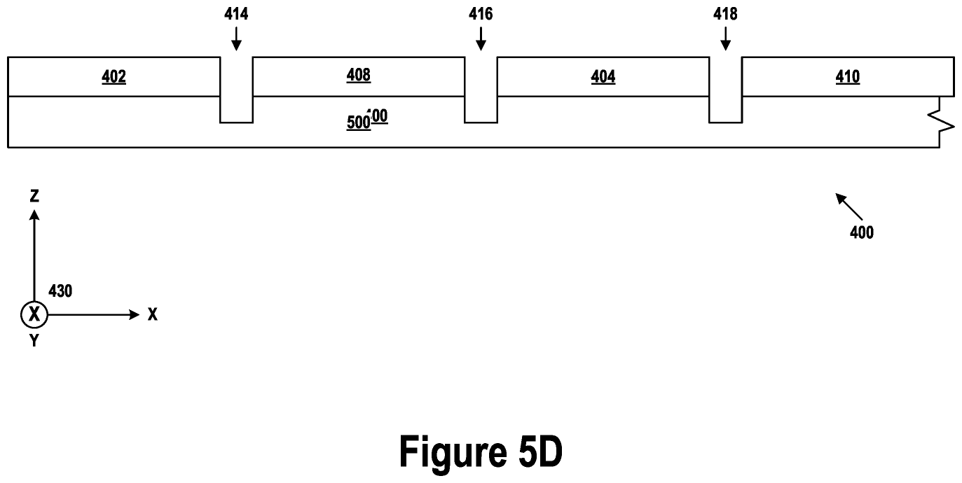

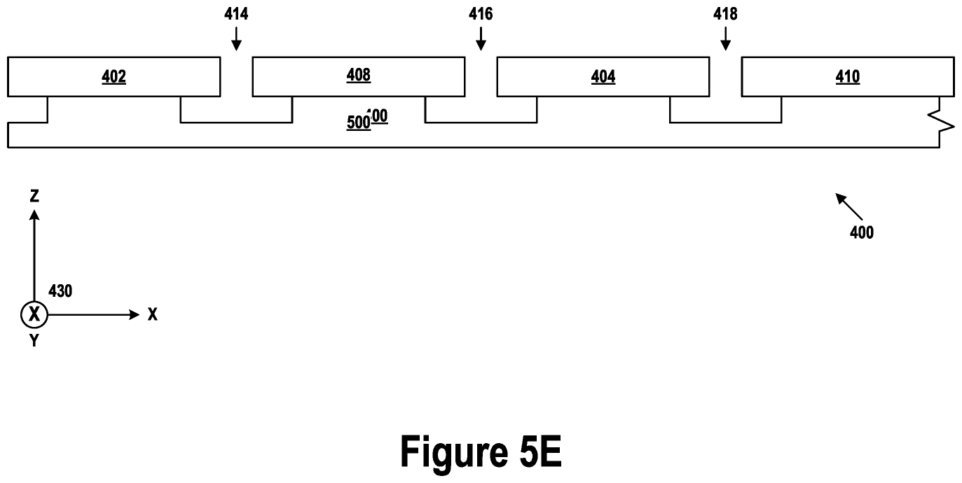

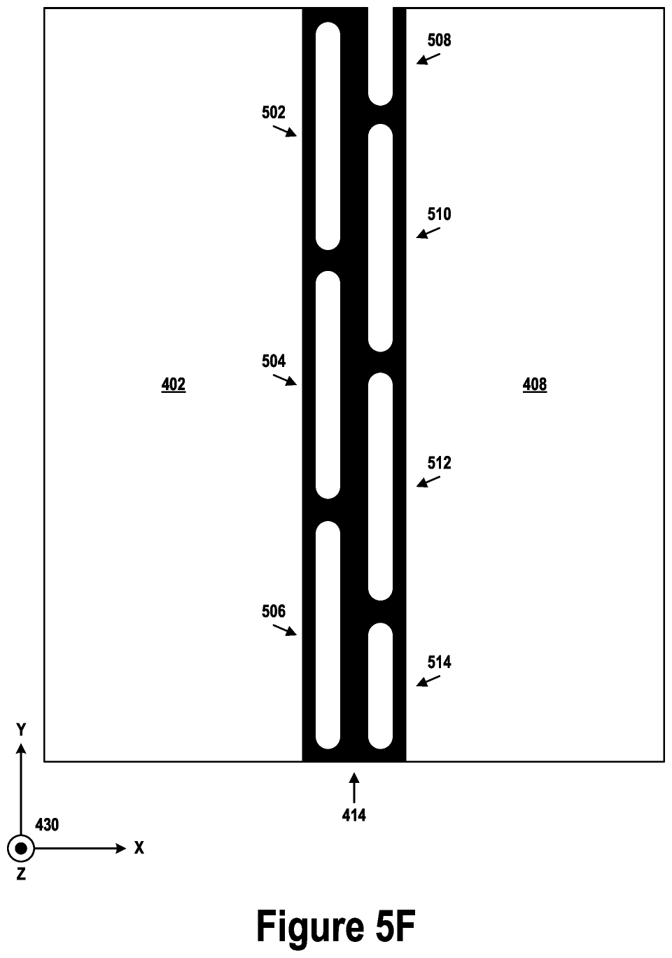

As noted in connection with FIG. 4A, charge pad 400 may include barriers 414-422 configured to physically and electrically separate adjacent charger terminals. Barriers 414-422 may be arranged to prevent and/or impede the formation of an inadvertent conductive path between two or more adjacent charger terminals when a conductive liquid such as water is disposed on charge pad 400. FIGS. 5A-5F illustrate various structures and/or arrangements of barriers 414-422 that are configured to reduce the likelihood of a conductive liquid forming an electrical connection between adjacent charger terminals.

FIG. 5A illustrates a cross sectional view (i.e., looking down the y-axis of reference frame 430) of an example implementation of charge pad 400 that uses one or more layers of hydrophobic material to form at least some of barriers 414-422. Specifically, substrate 500 of charge pad 400 may include charger terminals 402-412 disposed thereon, with adjacent charger terminals separated from one another by respective gaps. Each respective barrier of barriers 414-422 may be formed by hydrophobic material disposed in a corresponding gap of the respective gaps. The hydrophobic material may be configured to repel water, thereby preventing and/or reducing the likelihood of formation of inadvertent conductive paths across adjacent charger terminals.

The hydrophobic material may be hydrophobic in that it may have a lower hydrophilicity than the material used to form at least the top surface of charger terminals 402-412. For example, when at least the top surfaces of charger terminals 402-412 are formed using silver, the hydrophobic material may be selected to have a lower hydrophilicity than the silver. Accordingly, water may be repelled from barriers 414-422 and onto charger terminals 402-412, thus allowing adjacent charger terminals to remain electrically isolated from one another.

The hydrophobic material may include polytetrafluoroethylene (PTFE), Perfluoroalkoxy alkane (PFA), other perfluoro polymers, Ethylene-vinyl acetate (EVA), polypropylene, polyethylene (PE), polyamides, fluorinated ethylene propylene (FEP), Polychlorotrifluoroethylene (PCTFE), thermoplastic adhesives, polysilanes (e.g., silicone), wax, hot-melt glue/adhesive, nylon, and/or combinations thereof, among other possibilities. The hydrophobic material may be applied to substrate 500 using an adhesive, chemical deposition, extrusion, curing, thermoforming (e.g., melting the hydrophobic material onto charge pad 400), overmolding, welding (e.g., solvent welding, sonic welding, heat welding, etc.), dovetail slotting, and/or another suitable manufacturing process. Additionally and/or alternatively, the hydrophilicity of at least the top surface of charger terminals 402-412 may be increased (thereby decreasing the hydrophilicity of barriers 414-422 relative to charger terminals 402-412) by oxidizing the silver that forms the top surface (e.g., using anodizing and/or liver of sulfur).

In some implementations, the top surfaces of barriers 414-422 may be located at substantially the same height along the z-axis of reference frame 430 as the top surfaces of charger terminals 402-412. Thus, water may be removed from barriers 414-422 as a result of the difference in hydrophilicity. In other implementations, the top surfaces of barriers 414-422 may be located at a greater height along the z-axis than the top surfaces of charger terminals 402-412. Thus, water removal from barriers 414-422 may be aided by both the difference in hydrophilicity and gravitational forces.

FIG. 5B illustrates a cross sectional view of another example implementation of charge pad 400 that uses a physical ridge to form at least some of barriers 414-422. Specifically, each of barriers 414-422 may be shaped to have a respective triangular ridge extending higher than the top surface of charger terminals 402-412. The physical ridges of barriers 414-422 may have other shapes. For example, FIG. 5C illustrates a cross sectional view of an example implementation of charge pad 400 that uses semicircular physical ridges to form at least some of barriers 414-422. Specifically, each of barriers 414-422 may be shaped to have a respective semicircular ridge extending higher than the top surface of charger terminals 402-412. Additionally or alternatively, barriers 414-422 may have rectangular ridges, oval ridges, and/or irregular ridges, among other possibilities. The ridges illustrated in FIGS. 5B and 5C may alternatively be referred to as protrusions, hills, rims, separations, and/or elevations, among other possibilities.

The respective ridge of each of barriers 414-422 may operate to electrically isolate adjacent charger terminals by physically preventing conductive liquids such as water from spanning across the respective ridge. Specifically, the respective ridge may have a height along the z-axis of reference frame 430 that is based on a size (e.g., average size, maximum size, etc.) of a water droplet and/or a droplet of another conductive liquid expected to be present in the environment. Thus, the ridges of barriers 414-422 may be sized to break up liquid droplets before these droplets can electrically connect adjacent charger terminals. For example, the ridges of barriers 414-422 may each have a height of at least three millimeters (e.g., measured from the top of charger terminals 402-412 up along the z-axis), and may thus be expected to prevent most water droplets from spanning across any one of barriers 414-422. The height of the ridges of barriers 414-422 may be further increased to, for example, up to 9 millimeters to further increase the range of liquid droplet sizes that the ridges will break up.

The ridges of barriers 414-422 may be formed using a plastic polymer (e.g., hot-melt adhesive/glue, molded plastic, epoxy, etc.) and/or a polysilane (e.g., silicone), among other possibilities. In some implementations, the ridges of barriers 414-422 may be made of a material different from that of substrate 500, and may thus be attached to substrate 500 (e.g., using an adhesive, a dovetail, a T-shaped slot, etc.). In other implementations, barriers 414-422 and the ridges thereof may be integrated with substrate 500 and thus made of the same material as substrate 500.

FIG. 5D illustrates a cross sectional view of a further example implementation of charge pad 400 that uses a physical channel to form at least some of barriers 414-422. Specifically, each of barriers 414-422 may be formed by a channel defined in substrate 500 between adjacent charger terminals. The channel may alternatively be referred to as a tunnel, canal, canyon, duct, and/or gutter, among other possibilities. The depth and/or width of the channels that make up barriers 414-422 may be varied to increase the path length that conductive liquids such as water would have to span before creating a conductive path between adjacent charger terminals.

For example, FIG. 5E illustrates a cross sectional view of a yet further example implementation of charge pad 400 that uses physical channels extending both between and partly under adjacent charger terminals to form at least some of barriers 414-422. Specifically, at least part of the respective channel of each of barriers 414-422 may be wider than that shown in FIG. 5D, resulting in increased channel volume. Accordingly, the corresponding channels of barriers 414-422 may thus extend under adjacent charger terminals, resulting in at least a portion of each of charger terminals 402-412 overhanging at least part of a corresponding channel. The increased size of the channels shown in FIG. 5E increases the amount of water necessary to span adjacent charger terminals, thus reducing the likelihood of inadvertent electrical connections between adjacent charger terminals. Although the channels of barriers 414-422 are shown as having a rectangular cross section in FIGS. 5D and 5E, in other implementations the cross sections of barriers 414-422 may be circular, oval, triangular, and/or irregular, among other possibilities.

FIG. 5F illustrates a top-down view of a yet further example implementation of charge pad 400 that uses a channel screen in connection with at least some of the channels of barriers 414-422. Specifically, when a width of the openings of the channels of barriers 414-422 (e.g., as illustrated in FIGS. 5D and 5E) is larger than a size of one or more components (e.g., pogo pins) of the vehicle that make contact with charge pad 400, these components of the vehicle may get stuck in and/or snagged on the channels, thereby impeding motion of the vehicle relative to charge pad 400. Accordingly, each channel may be protected by a corresponding channel screen that includes a plurality of channel inlets.

For example, barrier 414 may include a channel screen that includes channel inlets 502, 504, 506, 508, 510, 512, and 514 (“channel inlets 502-514”). A width of each of channel inlets 502-514 (measured along the x-axis) may be approximately a quarter of a width of the channel of barrier 414. Additionally, a length of each of each of channel inlets 502-514 (measured along the y-axis) may be smaller than (e.g., ⅓, ¼, ⅕, etc. of) a length of the channel of barrier 414. Thus, channel inlets 502-514 may allow liquids present on the surface of charge pad 400 to enter into and drain out using the channels of barriers 414-422 while reducing the likelihood of vehicle components getting stuck in and/or snagged on the opening to these channels. By covering the channels of barriers 414-422 with a channel screen, the width of the channel openings may be increased to increase the path length between adjacent charger terminals without increasing the likelihood of the vehicle getting stuck in and/or snagged on the channel opening.

### VIII. Additional Liquid Removal Structures

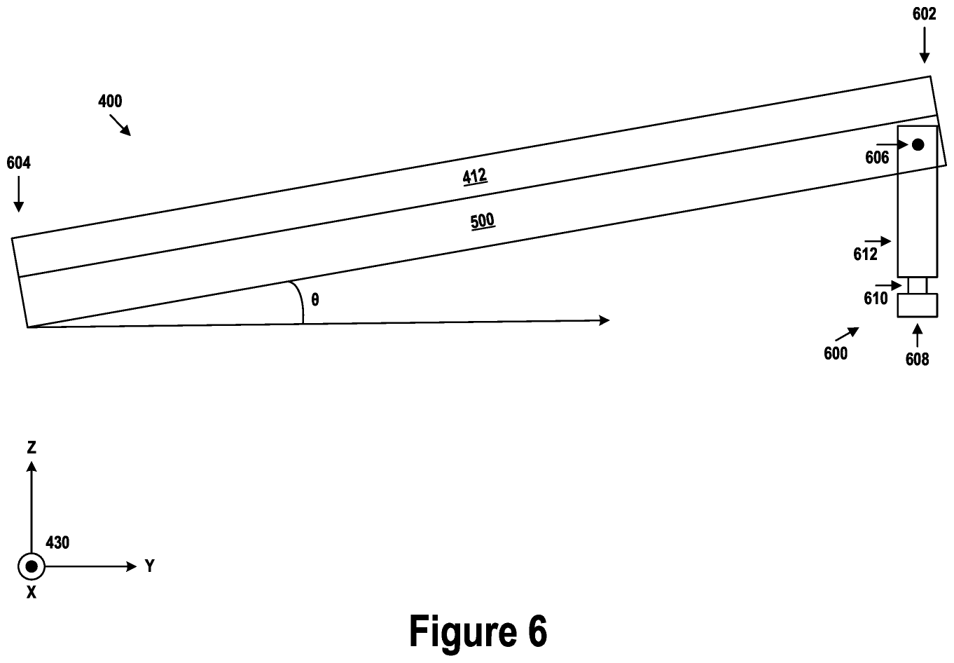

FIG. 6 illustrates a side view (along the x-axis) of charge pad 400 equipped with adjustable leg 600. Adjustable leg 600 may be configured to provide for an adjustment of a height of top end 602 of charge pad 400 relative to a bottom end 604 of charge pad 400. Elevating top end 602 above bottom end 604 may allow a liquid disposed on the surface to charge pad 400 to more easily run off from charge pad 400, thereby reducing the likelihood of inadvertent electrical connections forming between adjacent charger terminals. A length and/or an orientation of adjustable leg 600 may be adjustable to control a height of top end 602 relative to bottom end 604.

In some implementations, adjustable leg 600 may include a plurality of portions, at least some of which may be moveable relative to one another to allow for changes to the length of adjustable leg 600. For example, adjustable leg 600 may include foot portion 608, post portion 610, and housing portion 612. Post portion 610 may be disposed within and configured to move relative to housing portion 612. Foot portion 608 may be connected to a first end of post portion 610. Thus, as post portion 610 moves relative to housing portion 612, foot portion 608 may also move relative to housing portion 612, thereby shortening or lengthening adjustable leg 600.

A length by which post portion 610 is extended relative to housing portion 612 may be adjusted in a plurality of ways. As one example, post portion 610 may be threaded, and may be configured to screw into and out of corresponding threads in housing portion 612 (foot portion 608 may thus be a swivel foot). As another example, post portion 610 may be configured to slide relative to housing portion 612. A length of adjustable leg 600 may be at least temporarily fixed using a locking pin, a spring pin, a latch, and/or another mechanism configured to constrain a position of post portion 610 relative to housing portion 612. As a further example, post portion 610 may include a plurality of post sections that form a telescoping mechanism in combination with housing portion 612.

In some implementations, adjustable leg 600 may be configured to pivot relative to at least part of charge pad 400. For example, adjustable leg 600 may be configured to pivot about pivot point 606 on substrate 500 and/or another structure on which substrate 500 is disposed. Thus, adjustable leg 600 may operate in a manner similar to a kick stand, where adjustable leg 600 may be folded into and/or along substrate 500 for storage and/or deployed into an open position (e.g., as shown in FIG. 6) when used in the field.

Adjustable leg 600 may additionally or alternatively be implemented using other mechanisms that allow for an adjustment of the height of top end 602 relative to bottom end 604. In one example, adjustable leg 600 may include a plurality of stackable sections (e.g., operating similarly to building blocks, where stackable sections may be removed to decrease the height and/or added to increase the height. In a second example, adjustable leg 600 may include a multi-position adjustment bracket (e.g., similar to the mechanism used to adjust a recline position of lounge chairs), where the height may be adjusted in predetermined increments by placing a support brace into one of the positions of the multi-position adjustment bracket. In a third example, adjustable leg 600 may include a trifold support (e.g., similar to the mechanism used by a folio case of a tablet computer), where the height may be adjusted by folding or unfolding the trifold support. Other height control mechanisms may be used instead of or in combination with the mechanisms discussed above.

Adjustable leg 600 may be configured to allow for adjustments to the angle θ formed between a horizontal reference line and charge pad 400. The horizontal reference line may be substantially perpendicular to the Earth's gravity vector at the location of charge pad 400. For example, adjustable leg 600 may allow the angle θ to be adjusted to a value between zero degrees and at least three degrees when charge pad 400 is placed on a substantially level support surface. Three degrees of incline of charge pad 400 may be sufficient to effectively remove most liquids from the surface of charge pad 400. The value of the angle θ may be increased beyond three degrees to increase the rate at which liquids are removed from the surface of charge pad 400.

A maximum length to which adjustable leg 600 is configured to extend may be based on a maximum slope of a surface on which charge pad 400 is configured to be placed. For example, when charge pad 400 is expected to be placed (e.g., in the orientation shown in FIG. 6) on a support surface having up to four degrees of slope (e.g., directed downwards from left to right in FIG. 6), the angle of charge pad 400 relative to the support surface may be adjustable by up to 7 degrees to thereby allow the angle θ to be adjusted to a value between negative four degrees and at least three degrees. That is, adjustable leg 600 may provide sufficient adjustability to compensate for non-level support surfaces having up to a predetermined amount of incline/decline.

Additionally or alternatively, the maximum length to which adjustable leg 600 is configured to extend may be based on physical properties (e.g., size, positioning, actuation force, etc.) of one or more components of the vehicle(s) that use charge pad 400. As one example, when the vehicle is an aerial vehicle, the maximum length to which adjustable leg 600 is configured to extend may be based on a ground clearance of one or more propellers of the aerial vehicle to allow the aerial vehicle to land on and/or take off from charge pad 400 without striking top end 602. As another example, when the vehicle is a ground vehicle, the maximum length to which adjustable leg 600 is configured to extend may be based on the ground vehicle's ability to propel itself and any payload it may be carrying up the incline of charge pad 400.

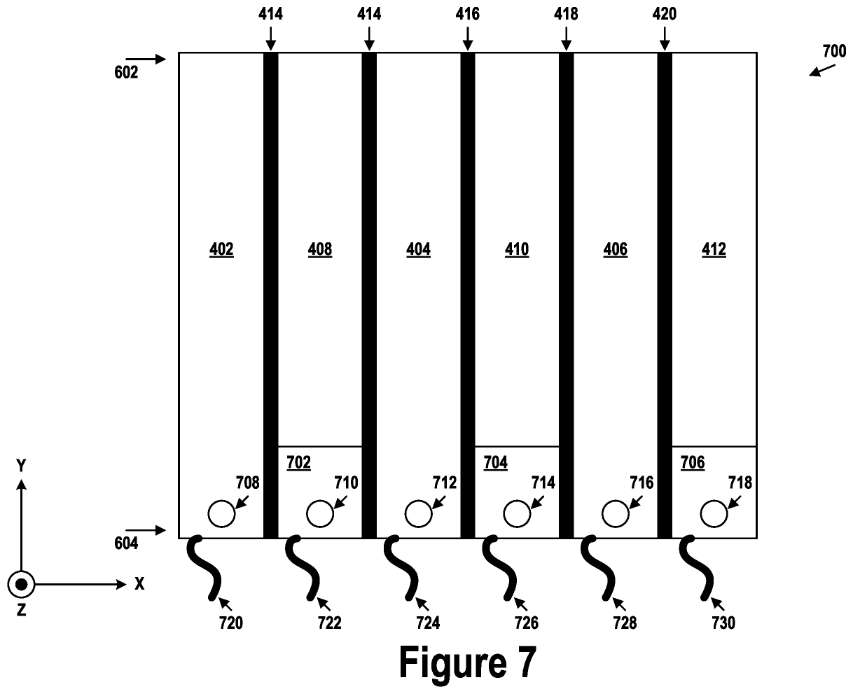

FIG. 7 illustrates charge pad 700 that includes charger terminals of varying lengths, drainage holes, and wicking material, each of which may assist with removal of liquids from the surface of charge pad 700, thus reducing and/or eliminating degradation of charge pad 700 in the presence of liquids. Charge pad 700 represents a variation of charge pad 400, and thus any of the structures of charge pad 700 may be included on charge pad 400, and vice versa.

Top end 602 of charge pad 700 may be elevated above bottom end 604 (e.g., using the adjustable leg of FIG. 6) to facilitate the draining of liquids from charge pad 700 at or near bottom end 604. Thus, charge pad 700 may include drainage holes positioned near bottom end 604 and extending through charge pad 700 to facilitate runoff of liquids from one side (e.g., a top side) of charge pad 700 to the other side (e.g., a bottom side) of charge pad 700. Specifically, charge pad 700 may include drainage holes 708, 710, 712, 714, 716, and 718 (“drainage holes 708-718”). For example, drainage holes 708-718 may be formed through regions of the substrate corresponding to, respectively, charger terminals 402, 408, 404, 410, 406, and 412.

Charge pad 700 may also include a wicking material connected near bottom end 604 and extending beyond charge pad 700 to promote removal of liquids from charge pad 700. Specifically, charge pad 700 may include wicking materials 720, 722, 724, 726, 728, and 730 (“wicking materials 720-730”). For example, wicking materials 720-730 may be connected to regions of the substrate corresponding to, respectively, charger terminals 402, 408, 404, 410, 406, and 412. Wicking materials 720-730 may include, for example, a rope, string, and/or cloth that includes cotton, fiberglass, woven plastic, wool, nylon, and/or cellulose, among other possibilities.

In some cases, incomplete draining of liquids from charge pad 700 may cause some liquid residue to remain at or near bottom end 604. To further reduce the likelihood of such liquid residue causing inadvertent electrical connections between adjacent charger terminals, the lengths of charger terminals 402-412 may be varied. For example, each of charger terminals 402-406 may extend along a first length between top end 602 and bottom end 604 of charge pad 700. In some cases, the first length may be equal to a length of charge pad 700 along the y-axis. Each of charger terminals 408-412 may extend along a second length between top end and bottom end 604 of charge pad 700. The second length may be shorter than the first length such that a portion of the substrate near bottom end 604 is left exposed by the absence of charger terminal material.

Specifically, substrate portions 702, 704, and 706 may be exposed by, respectively, charger terminals 408, 410, 412 not extending all the way to bottom end 604 of charge pad 700. Since substrate portions 702, 704, and 706 are nonconductive, liquid residue that bridges across any one of barriers 414-420 near bottom end 604 might not cause inadvertent electrical connections between adjacent charger terminals.

The techniques, structures, methods, and/or approaches described in connection with FIGS. 4A-7 may be used independently of one another or in combination with one another. That is, any one of the examples and/or embodiments illustrated in and/or discussed with respect to FIGS. 4A-7 may be used in combination with one or more other examples and/or embodiments illustrated in and/or discussed with respect to FIGS. 4A-7.

For example, charge pad 400 may include charger terminals 402-412 formed using silver and having alternating lengths (thus exposing substrate portions 702-706), barriers 414-422 that utilize ridges coated with a hydrophobic material, drainage holes 708-718, wicking materials 720-730, and adjustable leg 600. As another example, charge pad 400 may include charger terminals 402-412 formed using a metal other than silver, barriers 414-422 that utilize the channels depicted in FIG. 5E and the channel screen depicted in FIG. 5F, and adjustable leg 600. As a further example, charge pad 400 may include charger terminals 402-412 formed using silver, but might not include any of the other techniques, structures, methods, and/or approaches described in connection with FIGS. 4A-7. As a yet further example, some of barriers 414-422 may utilize the ridges of FIGS. 5B and/or 5C, while other ones of barriers 414-422 utilize the channels of FIGS. 5D and 5E.

### IX. Additional Example Operations

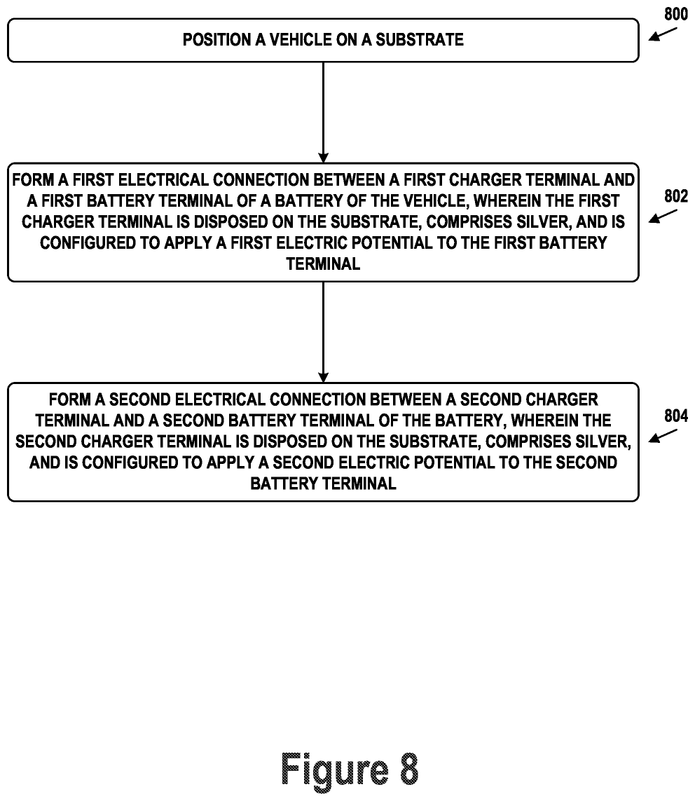

FIG. 8 illustrates a flow chart of operations related to using a battery charge pad to charge a battery of a vehicle. The operations may be carried out by and/or in connection with charge pad 400, charge pad 700, and/or one or more vehicles utilizing one or more of these charge pads, among other possibilities. The embodiments of FIG. 8 may be simplified by the removal of any one or more of the features shown therein. Further, these embodiments may be combined with features, aspects, and/or implementations of any of the previous figures or otherwise described herein.

Block 800 may involve positioning a vehicle on a substrate.

Block 802 may involve forming a first electrical connection between a first charger terminal and a first battery terminal of a battery of the vehicle. The first charger terminal may be disposed on the substrate, may include silver, and may be configured to apply a first electric potential to the first battery terminal.

Block 804 may involve forming a second electrical connection between a second charger terminal and a second battery terminal of the battery. The second charger terminal may be disposed on the substrate, may include silver, and may be configured to apply a second electric potential to the second battery terminal.

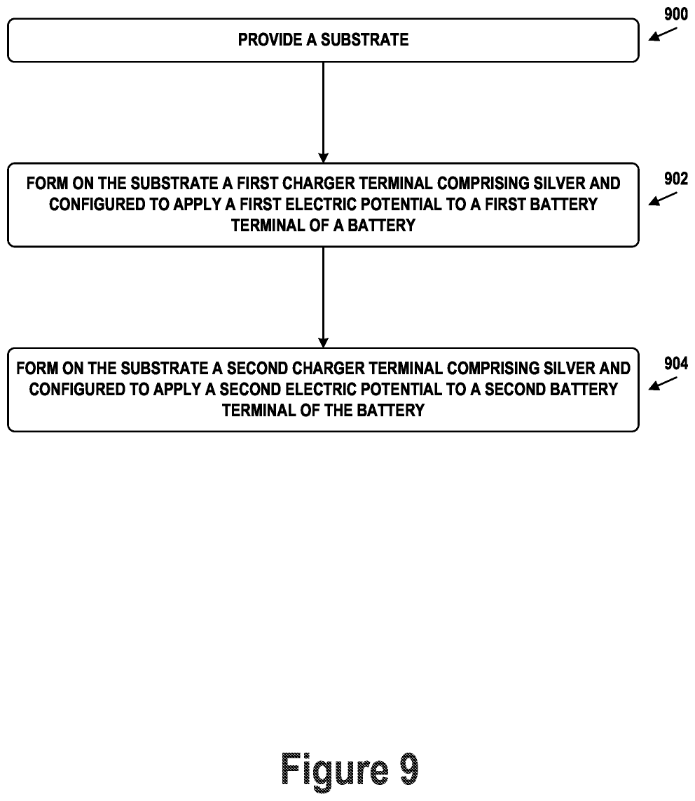

FIG. 9 illustrates a flow chart of operations related to manufacturing a battery charge pad configured to charge a battery. The operations may be carried out to manufacture aspects of charge pad 400 and/or charge pad 700, among other possibilities. The embodiments of FIG. 9 may be simplified by the removal of any one or more of the features shown therein. Further, these embodiments may be combined with features, aspects, and/or implementations of any of the previous figures or otherwise described herein.

Block 900 may involve providing a substrate.

Block 902 may involve forming on the substrate a first charger terminal that includes silver and is configured to apply a first electric potential to a first battery terminal of a battery.

Block 904 may involve forming on the substrate a second charger terminal that includes silver and is configured to apply a second electric potential to a second battery terminal of the battery.

In some examples, each of the first charger terminal and the second charger terminal may include a conductive body plated with the silver.

In some examples, the silver of the first charger terminal may be exposed to an ambient environment such that, when the first battery terminal is electrically connected to the first charger terminal, a first physical conductive path is formed between the first charger terminal and the first battery terminal by way of the silver. The silver of the second charger terminal may be exposed to the ambient environment such that, when the second battery terminal is electrically connected to the second charger terminal, a second physical conductive path is formed between the second charger terminal and the second battery terminal by way of the silver.

In some examples, each of the first charger terminal and the second charger terminal may include the silver and one or more of a silver electrochemical corrosion byproduct or a silver passivation byproduct.

In some examples, a corresponding size of each of the first charger terminal and the second charger terminal may be based on a distance between electrical connectors of a vehicle comprising the battery and configured to charge the battery via the first charger terminal and the second charger terminal.

In some examples, the apparatus may include a power supply configured to apply (i) the first electric potential to the first charger terminal and (ii) the second electric potential to the second charger terminal.

In some examples, the apparatus may include a barrier located on the substrate between the first charger terminal and the second charger terminal and configured to electrically isolate the first charger terminal and the second charger terminal by obstructing formation of a conductive path by way of a liquid (e.g., water resulting from precipitation in the environment) disposed on the substrate.

In some examples, the barrier may include a layer of hydrophobic material having a lower hydrophilicity than the silver.

In some examples, the hydrophobic material may include polytetrafluoroethylene.

In some examples, the barrier may include a ridge disposed on the substrate.

In some examples, the ridge may have a height of at least three millimeters.

In some examples, the barrier may include a channel in the substrate.

In some examples, the substrate may include a plurality of holes extending along the channel from a first side of the substrate into the channel to allow a liquid to run off from the first side of the substrate into the channel.

In some examples, the apparatus may include an adjustable leg connected to the substrate and configured to provide for an adjustment of a height of at least one end of the substrate relative to a surface in an environment.

In some examples, the adjustable leg may include one or more of: (i) a kickstand, (ii) two or more stackable sections, (iii) a threaded post, (iv) a swivel foot, (v) a spring pin, (vi) a latch, (vii) a telescoping tube, (viii) a multi-position adjustment bracket, or (ix) a trifold support.

In some examples, the adjustable leg may be configured to allow an angle of the substrate to be adjusted to a value between zero degrees relative to horizontal and at least three degrees relative to horizontal.

In some examples, the adjustable leg may be configured to allow an angle of the substrate to be adjusted to a value between zero degrees relative to horizontal and up to six degrees relative to horizontal.

In some examples, the adjustable leg may be configured to allow an angle of the substrate to be adjusted to a value between at least three degrees relative to horizontal and up to six degrees relative to horizontal.

In some examples, the adjustable leg may be configured to elevate a top end of the substrate above a bottom end of the substrate. The first charger terminal may extend along a first length between the top end of the substrate and the bottom end of the substrate. The second charger terminal may extend along a second length between the top end of the substrate and the bottom end of the substrate. The second length may be shorter than the first length such that a portion of the substrate near the bottom end thereof is exposed by the second charger terminal to prevent formation of a conductive path between the first charger terminal and the second charger terminal by way of a liquid disposed on the bottom end of the substrate.

In some examples, the substrate may include a hole extending from a first side of the substrate to a second side of the substrate to allow a liquid to run off from the substrate.

In some examples, the substrate may include a wicking material connected to the substrate and extending beyond the substrate to promote removal of the liquid from the substrate.

In some examples, each of the first charger terminal and the second charger terminal may include gold.

In some examples, each of the first charger terminal and the second charger terminal may include a conductive body plated with the gold.

### X. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. An apparatus comprising:
a substrate;
a first charger terminal disposed on the substrate, comprising silver, and configured to apply a first electric potential to a first battery terminal of a battery; and
a second charger terminal disposed on the substrate, comprising silver, and configured to apply a second electric potential to a second battery terminal of the battery.

2. The apparatus of claim 1, wherein each of the first charger terminal and the second charger terminal comprises a conductive body plated with the silver.

3. The apparatus of claim 1, wherein the silver of the first charger terminal is exposed to an ambient environment such that, when the first battery terminal is electrically connected to the first charger terminal, a first physical conductive path is formed between the first charger terminal and the first battery terminal by way of the silver, and wherein the silver of the second charger terminal is exposed to the ambient environment such that, when the second battery terminal is electrically connected to the second charger terminal, a second physical conductive path is formed between the second charger terminal and the second battery terminal by way of the silver.

4. The apparatus of claim 1, wherein each of the first charger terminal and the second charger terminal comprises the silver and one or more of a silver electrochemical corrosion byproduct or a silver passivation byproduct.

5. The apparatus of claim 1, wherein a corresponding size of each of the first charger terminal and the second charger terminal is based on a distance between electrical connectors of a vehicle comprising the battery and configured to charge the battery via the first charger terminal and the second charger terminal.

6. The apparatus of claim 1, further comprising:
a power supply configured to apply (i) the first electric potential to the first charger terminal and (ii) the second electric potential to the second charger terminal.

7. The apparatus of claim 1, further comprising:
a barrier located on the substrate between the first charger terminal and the second charger terminal and configured to electrically isolate the first charger terminal and the second charger terminal by obstructing formation of a conductive path by way of a liquid disposed on the substrate.

8. The apparatus of claim 7, wherein the barrier comprises a layer of hydrophobic material having a lower hydrophilicity than the silver.

9. The apparatus of claim 8, wherein the hydrophobic material comprises polytetrafluoroethylene.

10. The apparatus of claim 7, wherein the barrier comprises a ridge disposed on the substrate.

11. The apparatus of claim 10, wherein the ridge has a height of at least three millimeters.

12. The apparatus of claim 7, wherein the barrier comprises a channel in the substrate.

13. The apparatus of claim 12, wherein the substrate comprises a plurality of holes extending along the channel from a first side of the substrate into the channel to allow a liquid to run off from the first side of the substrate into the channel.

14. The apparatus of claim 1, further comprising:
an adjustable leg connected to the substrate and configured to provide for an adjustment of a height of at least one end of the substrate relative to a surface in an environment.

15. The apparatus of claim 14, wherein the adjustable leg comprises one or more of: (i) a kickstand, (ii) two or more stackable sections, (iii) a threaded post, (iv) a swivel foot, (v) a spring pin, (vi) a latch, (vii) a telescoping tube, (viii) a multi-position adjustment bracket, or (ix) a trifold support.

16. The apparatus of claim 14, wherein the adjustable leg is configured to allow an angle of the substrate to be adjusted to a value between zero degrees relative to horizontal and at least three degrees relative to horizontal.

17. The apparatus of claim 14, wherein the adjustable leg is configured to elevate a top end of the substrate above a bottom end of the substrate, wherein the first charger terminal extends along a first length between the top end of the substrate and the bottom end of the substrate, wherein the second charger terminal extends along a second length between the top end of the substrate and the bottom end of the substrate, wherein the second length is shorter than the first length such that a portion of the substrate near the bottom end thereof is exposed by the second charger terminal to prevent formation of a conductive path between the first charger terminal and the second charger terminal by way of a liquid disposed on the bottom end of the substrate.

18. The apparatus of claim 1, wherein the substrate comprises one or more of:
a hole extending from a first side of the substrate to a second side of the substrate to allow a liquid to run off from the substrate; or
a wicking material connected to the substrate and extending beyond the substrate to promote removal of the liquid from the substrate.

19. A system for charging a battery, the system comprising:
a substrate;
a first charger terminal disposed on the substrate, comprising silver, and configured to apply a first electric potential to a first battery terminal of the battery; and
a second charger terminal disposed on the substrate, comprising silver, and configured to apply a second electric potential to a second battery terminal of the battery.

20. A method comprising:
positioning a vehicle on a substrate;
forming a first electrical connection between a first charger terminal and a first battery terminal of a battery of the vehicle, wherein the first charger terminal is disposed on the substrate, comprises silver, and is configured to apply a first electric potential to the first battery terminal; and
forming a second electrical connection between a second charger terminal and a second battery terminal of the battery, wherein the second charger terminal is disposed on the substrate, comprises silver, and is configured to apply a second electric potential to the second battery terminal.
